(19) United States
(12) Patent Application Publication
(10) Pub. No.: US 2014/0165356 A1
(43) Pub. Date: Jun. 19, 2014

(54) CONVERSION OF A REFORMING PROCESS/UNIT INTO A PARTIAL NAPHTHA CRACKING PROCESS/UNIT

(71) Applicants: William J. Novak, Bedminster, NJ (US); David L. Johnson, Doylestown, PA (US); John H. Thurtell, Kuala Lumpur (MY); John P. Greeley, Gaithersburg, MD (US)

(72) Inventors: William J. Novak, Bedminster, NJ (US); David L. Johnson, Doylestown, PA (US); John H. Thurtell, Kuala Lumpur (MY); John P. Greeley, Gaithersburg, MD (US)

(73) Assignee: ExxonMobil Research and Engineering Company, Annandale, NJ (US)

(21) Appl. No.: 14/085,850

(22) Filed: Nov. 21, 2013

Related U.S. Application Data
(60) Provisional application No. 61/739,246, filed on Dec. 19, 2012.

(51) Int. Cl. B23P 6/00

(52) U.S. Cl. CPC B23P 6/00
USPC 29/401.1

(57) ABSTRACT

A cost effective method for reutilizing exiting refinery equipment associated with either a Reformer Unit or Isomerization Unit by converting such units into units and associated processes for hydrodesulfurizing and cracking naphtha feedstocks into light plant gases and chemical feedstocks. These existing Reformer or Isomerization units and processes can be converted into the processes described herein with very little capital expenditures, essentially utilizing almost all of the existing unit equipment, and with little to no major equipment replacements. The processes disclosed herein also effectively reduce the overproduction of naphtha currently experienced in many modern refineries that have resulted from a reduction in overall demand of gasoline products relative to other refinery products.

### CROSS-REFERENCE TO RELATED APPLICATIONS

This application claims priority to U.S. Provisional Application Ser. No. 61/739,246 filed Dec. 19, 2012, which is herein incorporated by reference in its entirety.

### FIELD

The present invention relates to converting petroleum refinery reforming (and optionally isomerization) processes and units into processes and units for the effective partial cracking of naphtha feedstocks. Preferably, the converted processes and units are utilized to maximize cracking naphtha into light petroleum gas (LPG) products, and more preferably, further maximizing the production of valuable chemical feedstock products such as ethylene and propylene.

### BACKGROUND

Over the past decade, while overall demand for hydrocarbon-based fuels (including transportation fuels) has been on the rise, worldwide demand for gasoline products has been on a steady decline. This is due to the fact that the gasoline market demand is driven almost completely by the need for its limited use as an automobile fuel. Additionally, while gasoline powered vehicles are predominant in the United States, the majority of the transportation fuels demand in foreign countries is for diesel fuel. This, combined with the fact that the major growth industries are outside of the United States, and that the U.S. automobile manufacturing and markets are moving to automobiles with significantly higher miles per gallon (mpg) requirements, the demand for gasoline fuels is projected to remain on a steady decline in the future. This decline in demand has resulted in suppressed pricing of gasoline motor fuels relative to diesel motor fuels as well as other uses for available hydrocarbon products such as light plant gases (LPGs) and chemical feedstocks.

Due to the age of most refineries (particularly in the U.S. where almost all refineries are over 30 years old), refineries have many existing refining units which are specifically designed to increase the production of gasoline and/or increase the quality of the gasoline produced. Each of these units are multi-million dollar capital asset value processes and in the face of the suppressed gasoline and prediction of further suppression in the future, many refiners have decreased the throughput through these existing units or are faced with shutting down these gasoline upgrading units altogether.

One of the major gasoline producing units in modern refineries is the Fluid Catalytic Cracking (FCC) Unit. This is the workhorse in the refinery for volumetric production of naphtha (refinery fraction used for gasoline fuels) from heavier hydrocarbon feedstocks. Due to the extremely high throughput of these units and their relatively large associated capital value (most FCCs range in the tens of million dollars to construct), most refiners have attempted to shift the FCC units to lower gasoline production and higher distillate (refinery fraction used for diesel fuels) production.

However, most existing refineries also have at least one Reforming unit. In the Reforming unit, naphtha fractions are upgraded in octane number for use as high-octane blending components for gasoline. In the U.S., a gasoline's octane number is calculated by RON+MON/2. That is, the posted octane numbers at the gasoline pumps is the numerical average of the Research Octane Number (RON) and the Motor Octane Number (MON). Reforming units (unlike FCC units) do not increase the volume of the naphtha produced, but instead increase this octane number of the naphtha treated in the unit. This is done in the Reforming unit by exposing the naphtha to a specialized reforming catalyst at elevated temperatures (typically above about 900° F.). The reforming catalyst typically contains at least one Group VIII noble metal (usually platinum, Pt, although other metals such as Re or Pd may be utilized), wherein the noble metal is deposited on a support such as alumina.

In the Reforming process, typically a highly paraffinic naphtha fraction is utilized as a feedstock and during the reforming reaction in the presence of the reforming catalyst, some of the paraffinic naphtha feedstock is dehydrocyclized or isomerized (i.e. “reformed”), thus increasing the octane number of the treated naphtha and thus increasing the value of the treated naphtha as a gasoline blendstock. An additional benefit of the reforming process is that some hydrogen is also generated, generally as a result of the dehydrocyclization reactions.

The largest licensor of Reforming processes in UOP® which markets this process under the name of UOP Platforming® process. The Platforming process is typically comprised of three (3) stages, each stage containing a reformer reactor section. Some of the existing refinery Platforming units, particularly the older ones, are “fixed reactor bed” designs. However, many of the newer refinery Platforming units are of the CCR® Platforming design. Here, in the CCR Platforming units, the catalyst continually moves through each of the reactor beds (generally reactor stages 1 to 2 to 3) and then the catalyst is regenerated and cycled back for use. In the CCR Platforming units, a system of lock hoppers are utilized to move the catalyst through the system as well as isolate one reactor stage from the next in the reforming process. Alternatively, other Reforming processes are licensed under such names as Powerforming® (ExxonMobil® Corporation) and Ultraforming® (British Petroleum® Company) which are based on the “fixed reactor bed” design.

Additionally, many refineries also have Isomerization units. Like Reforming units, in the Isomerization units, a paraffinic naphtha fraction (often a “light” naphtha fraction) is utilized as a feedstock. Here, during the isomerization reaction in the presence of the isomerization catalyst, some of the paraffinic naphtha feedstock is isomerized, thus increasing the octane number of the treated naphtha and thus increasing the value of the treated naphtha as a gasoline blendstock. Although the reforming catalysts and isomerization catalysts are different, like the reforming catalyst, the isomerization usually contains at least one Group VIII noble metal (usually platinum, Pt), wherein the noble metal is deposited on a support such as alumina.

One such Isomerization process is licensed by UOP under the name of the Pentex® process. While the Platforming process utilizes three (3) reactors/stages configured in series, many of the Pentex process units utilize a configuration with two (2) reactors/stages in series. Additionally, while most isomerization units tend to be smaller in size than the reforming units, they typically have a significantly lower operating and maintenance cost.

One of the main problems facing the industry is that in many refineries, due to the reduction in naphtha (gasoline blendstock) value and production, these Reforming units or Isomerization units simply are not profitable. Their limited use in increasing gasoline octane as well as produce some hydrogen cannot overcome their operating and maintenance costs in many operating refineries. The incremental hydrogen that is produced by the Reforming units can most often now be made by lower cost processes or can be purchased more economically via gas pipelines from third party suppliers. As a result, many of these existing Reforming or Isomerization processes, and their associated equipment, are operated at very low throughputs and/or profit margins. In many refineries, these units are simply not profitable and the units, with their associated equipment, are simply shutdown.

This is especially true in the case of Reforming units which are very costly to operate and maintain. The capital equipment alone in each of these reforming units is valued well over millions of U.S. dollars. As such, due to low economics for naphtha (gasoline) production and the relatively low cost option for purchased hydrogen, these units no longer have use and these existing capital assets are underutilized or taken out of service.

Therefore, there is a need in the industry for procedures and processes in which these Reforming unit and Isomerization unit capital assets can be utilized in profitable refinery process operations. Particularly, it would be beneficial if the equipment revamp/restructuring requirements would be minimal and the new process would be tailor fit to their existing process configurations with minimal major equipment modifications. Preferably, it would be beneficial if essentially no piece of major equipment (i.e., reactors, furnaces, significant vessels, etc.) associated with the existing Reforming unit and Isomerization unit would need to be replaced to convert the unit to another profitable refinery process.

### SUMMARY OF EMBODIMENTS

In an embodiment in accordance with the present invention, there is provided a method for converting a naphtha octane upgrading unit into a naphtha cracking unit comprising:
a) shutting down an existing naphtha octane upgrading unit;
b) removing the existing catalyst from the unit;
c) installing a first naphtha hydrotreating catalyst in at least one first existing reactor of the naphtha octane upgrading unit, wherein the at least one first existing reactor of the naphtha octane upgrading unit becomes part of the first stage of a naphtha cracking process;
d) installing a naphtha cracking catalyst in at least one second existing reactor of the naphtha octane upgrading unit, wherein the at least one second existing reactor stage is in flow series subsequent to the at least one first existing reactor, and the at least one second existing reactor of the naphtha octane upgrading unit becomes part of the second stage of the naphtha cracking process; and
e) modifying existing instrumentation and controls equipment in the first and second stages of the naphtha cracking process to operate under the conditions of the naphtha cracking process.

In yet another embodiment, there is provided a method for converting a naphtha octane upgrading unit for use in a naphtha cracking process comprising:
a) shutting down an existing naphtha octane upgrading unit;
b) removing the existing catalyst from the unit;
c) installing a first naphtha hydrotreating catalyst in at least one first existing reactor of the naphtha octane upgrading unit, wherein the at least one first existing reactor of the naphtha octane upgrading unit becomes part of the first stage of the naphtha cracking process;
d) installing a naphtha cracking catalyst in at least one second existing reactor of the naphtha octane upgrading unit, wherein the at least one second existing reactor stage is in flow series subsequent to the at least one first existing reactor, and the at least one second existing reactor of the naphtha octane upgrading unit becomes part of the second stage of the naphtha cracking process;
e) modifying existing instrumentation and controls equipment in the first and second stages of the naphtha cracking process to operate under conditions associated with the naphtha cracking process;
f) conducting a first naphtha feed fraction to the at least one first existing reactor of the naphtha octane upgrading unit;
g) contacting the first naphtha feed fraction with the first naphtha hydrotreating catalyst in the at least one first existing reactor of the naphtha octane upgrading unit under first naphtha hydrotreating conditions to form a first hydrotreated naphtha product;
h) conducting at least a portion of the first hydrotreated naphtha product to the at least one second existing reactor of the naphtha octane upgrading unit;
i) contacting the first hydrotreated naphtha product with the naphtha cracking catalyst in the at least one second existing reactor of the naphtha octane upgrading unit under naphtha cracking conditions to form a first cracked naphtha product; and
j) separating the first cracked naphtha product into at least one light petroleum gas fraction and at least one naphtha fraction.

### DETAILED DESCRIPTION OF EMBODIMENTS OF THE INVENTION

In an embodiment of the invention herein is a method for converting an existing Reformer unit or Isomerization unit (such units collectively referred to herein as a “naphtha octane upgrading unit”) into a naphtha cracking unit. In another embodiment of the invention is a method for converting an existing Reformer unit or Isomerization unit and operating the associated equipment as a naphtha cracking process.

As discussed in the Background section above, the existing Reforming units herein will typically be comprised of at least three (3) stages each stage comprised of at least one (1) reforming reactor. These Reforming units can either be in a “fixed bed” configuration wherein the catalyst in each reactor is fixed or stationary, or they can be in a “circulating catalyst” configuration (such as the CCR Platforming configuration) wherein the catalyst is circulated from reactor to reactor and then regenerated and sent back to the reactor process. These Platforming configurations and associated processes are known to those of skill in the art. The reader is also directed to the Handbook of Petroleum Refining Process (R. Meyers, editor, McGraw-Hill Companies, Inc., 2nd Ed., 1997, pp. 4.3-4.26) for general information regarding configuration and operation of the Platforming processes. These processes are specifically designed for upgrading the octane of a naphtha feedstream while minimizing naphtha conversion with generally less than about 2 wt % naphtha conversion (naphtha loss) in a typical Reforming unit/process.

As noted prior, a problem in the industry is that with the severe and prolonged forecasted downturn in the worldwide, as well as U.S., demand of gasoline, many existing Reforming units are underutilized, non-profitable, or are being shutdown. This leaves millions of U.S. dollars of refinery assets per unit that are either underutilized or not utilized at all. The present invention is a process for converting the assets of a Reforming unit, or similarly an Isomerization unit (which are collectively referred to herein as “naphtha octane upgrading unit”), into a profitable refinery process with very little capital expense (i.e., very little equipment upgrade or replacement). Preferably, the conversion is performed with requiring no (or essentially no) piece of major equipment (i.e., reactors, furnaces, significant vessels, etc.) associated with the existing Reforming unit and Isomerization unit to be replaced. The present invention encompasses a novel process that utilizes the Reforming (or Isomerization) unit equipment and process configuration with little or essentially no major required equipment or configuration changes. Generally what would be required to practice the conversions described in this invention would be minor equipment modifications such as sizing of control valves, orifice plates, etc.; addition or reconfiguration of minor instrumentation such as temperature or pressure probes, etc.; and/or minor changes or reconfiguration of control logic. These all can be done with very minor capital expense and manpower.

In portions of the descriptions herein, for simplicity purposes we may refer to a “Reforming unit”, but such teachings and procedures will be equally applicable to and understandable by one of skill in the art as they apply to the revamping of an Isomerization unit. The main difference between the Reforming unit and Isomerization unit configuration is that the Reforming Unit will generally have a three (3) reactor/stage configuration (although four may also be used) with a heater (which for purposes herein also includes the use of a “dedicated section of a main heater”) prior to the reactor(s) of each stage reactors, while the Isomerization unit will generally have a two (2) reactor/stage configuration with only one heater prior to the reactors. However, the Isomerization unit will generally have a heat exchanger between the first and second stage reactors to supply additional heat to the process between stages. To help illustrate, the reader is also directed to the Handbook of Petroleum Refining Process (R. Meyers, editor, McGraw-Hill Companies, Inc., 2nd Ed., 1997, pp. 9.15-9.27) for general information regarding configuration and operation of the Pentex process.

The conversion of these units and the associated novel processes herein is very conducive to reutilizing almost all of the existing equipment in these Reforming or Isomerization units with only minor modifications and then utilizing this equipment in a process that can be profitable to refineries. In particular, as noted prior, these existing Reforming units and Isomerization units are dedicated to process for “reforming” and/or “isomerizing” naphtha feedstreams to increase the octane of the naphtha. The refinery “naphtha” fraction is used as the main gasoline blending fraction in a refinery. In these existing reforming and isomerization processes, it is important that the loss of the naphtha be minimized, and as such, the Reforming and Isomerization processes are run to minimize naphtha conversion (loss) to less than about 2 wt %. It should also be noted that the Reforming and Isomerization processes do not substantially remove any sulfur from the naphtha feedstreams; these existing processes are used substantially to only increase the octane of the naphtha feed, again with minor naphtha fraction losses.

In contrast, in the present invention, these Reforming or Isomerization units are revamped to a completely different catalytic process that 1) removes sulfur in the naphtha, preferably to product levels of sulfur less than 30 wppm, or even less than 15 wppm, or even less than 5 wppm, to meet current low sulfur gasoline specifications, 2) converts a large portion of the naphtha fraction (which is being overproduced in current refineries) to more marketable light plant gases (LPGs), and 3) increases the production of chemical feedstocks (ethylene and propylene) as a result the process. All of the factors combined can turn an unprofitable, low-profitable, or even shutdown Reforming unit or Isomerization unit into a profitable refinery asset.

The term “naphtha” as utilized herein, and unless otherwise noted or further defined, can refer to any naphtha fraction in a refinery. The term naphtha (or naphtha fraction) generally applies to fractions that boil substantially on the range of from about 80 to about 450° F. (26.7 to 232.2° C.). In preferred embodiments, the naphtha has a T5 boiling point of about 80° F. (26.7° C.) and a T95 boiling point of about 450° F. (232.2° C.). The term “T5” (an industry term), defines the temperature at which 5 wt % of the specific referenced fraction boils off at atmospheric pressure. Similarly, the term “T95”, defines the temperature at which 95 wt % of the specific referenced fraction boils off at atmospheric pressure.

To explain the embodiments of the invention herein, we will explain the process of converting the unit and operating the new process in equivalent terms of a “Reforming unit”, “reforming unit”, “Reformer” or “reformer”. However, with this description, it will be clear to one of skill in the art how these teachings and implementation will be applicable to an Isomerization unit.

In an embodiment of the present invention, a Reforming unit is taken out of service or “shutdown”. The reforming catalyst is removed from each of the existing reforming reactors. As noted prior, this is generally a Pt (or other noble metal) containing catalyst specially designed to convert paraffinic naphtha molecules into aromatic naphtha. As noted prior, the reforming processes generally have three (3) reaction stages.

In the CCR configuration, there is usually only one reactor for each of the three stages. Normally, in the CCR configuration the reactor of each progressive stage is larger than the reactor of the prior stage (this can be seen illustrated in the Handbook of Petroleum Refining Process, Id., p. 4.6). In the present embodiment, a naphtha hydrotreating catalyst is installed in at least the first stage reactor. Preferably, a naphtha hydrotreating catalyst is also installed in the second stage reactor. In embodiments, the naphtha hydrotreating catalyst installed in the first stage reactor can be the same or different than the naphtha hydrotreating catalyst installed in the second stage reactor. Alternatively, the reactors containing the naphtha hydrotreating catalyst can have more than one catalyst bed, each with the same or differing naphtha hydrotreating catalysts.

Continuing with these embodiments, a naphtha cracking catalyst is installed in at least the last (here the third stage) reactor. Alternatively, a naphtha cracking catalyst can be installed in the intermediary (here the second stage) reactor. In some embodiments, the intermediary reactor(s) can contain both a naphtha hydrotreating catalyst and a naphtha cracking catalyst in a stacked bed configuration. However, in the most preferred configuration, it is preferred that each reactor either have only naphtha hydrotreating catalyst(s) installed in the reactor or naphtha cracking catalyst(s) installed in the reactor.

In the three stage (three reactor) configuration of the CCR, in a preferred embodiment herein, the naphtha hydrotreating catalyst(s) are installed in at least the first and second (intermediary) reactors and the naphtha cracking catalyst(s) are installed in the third (or third stage, i.e. final) reactor(s). This is generally a preferred embodiment of the invention since the overall catalyst volume space in the reactors of each of the first and second stages are smaller than the volume space in the reactor(s) of the third stage.

These preferred configurations of the present invention with respect to the CCR are equally applicable to the conversion and implementation of the present invention with respect to a fixed-bed reforming unit (e.g., Platforming unit). In the fixed bed Platforming units, the reactor(s) in each stage progressive stage can have a larger catalyst volume, but this is not required. It should be noted that the terms “reactor(s)” and “stages” are utilized in the manner herein is due to the fact that while the reforming units will generally have three (3) reactor stages, each stage may have one or more reactors. In some embodiments of the reformer unit design, the overall reactor catalyst volume for each stage is increased simply by making the next stage reactor larger in size. However, in other embodiments of the reformer unit design, the overall reactor catalyst volume for each stage is increased by adding another reactor to the next stage. For example, a reformer configuration may be such that there is one reactor in the first stage, two reactors in the second stage, and three reactors in the third stage. Alternatively, a reformer configuration may be such that there is one reactor in the first stage, one reactor in the second stage, and two reactors in the third stage. Generally, if there is more than one reactor in a particular stage, the reactors in that stage are operated in a parallel flow configuration.

As such, in light of the present disclosures, the intent of the possible arrangements, particularly as they may apply to a specific exiting reformer equipment configuration, will be clear to one of skill in the art.

In the present embodiments, a naphtha hydrotreating catalyst is utilized that will reduce the sulfur content of the naphtha in each reaction stage that contains a naphtha hydrotreating catalyst. As noted, one or more naphtha hydrotreating catalysts may be utilized in the present invention.

Preferred naphtha hydrotreating catalysts for use in the naphtha hydrotreating stage(s) of the present invention are those that are comprised of at least one Group VIII metal oxide, preferably an oxide of a metal selected from Fe, Co and Ni, more preferably selected from Co and Ni; and at least one Group VI metal oxide, preferably an oxide of a metal selected from Mo and W, more preferably Mo. Preferably, the naphtha hydrotreating catalysts do not contain any noble metals (e.g., Pt or Pd), although some embodiments of the naphtha hydrotreating catalysts may not be so restricted. In preferred embodiments, the naphtha hydrotreating catalysts further includes a zeolite. As noted, one or more different naphtha hydrotreating catalysts may be utilized in the naphtha hydrotreating stage and may be located in separate or the same reactors. To clarify, the term “Group VI metal” as used herein refers to the Column 6 metals of the modern IUPAC Periodic Table of Elements, and the term “Group VIII metal” as used herein refers to the Columns 8-10 metals of the modern IUPAC Periodic Table of Elements.

While the Group VIII metal oxide and the Group VI metal oxide may be in the form of a bulk naphtha hydrotreating catalyst, preferably, in the naphtha hydrotreating catalysts utilized in the processes herein, the Group VIII metal oxide and the Group VI metal oxide are supported on a high surface area support material, preferably alumina. The Group VIII metal oxide of the naphtha hydrotreating catalysts is preferably present in an amount ranging from about 0.1 to about 20 wt %, preferably from about 1 to about 12 wt %. The Group VI metal oxide is preferably present in an amount ranging from about 1 to about 50 wt %, preferably from about 2 to about 20 wt %. All metal oxide weight percents expresses herein are based on the weight of the final catalyst.

The naphtha hydrodesulfurization catalysts used in the practice of the present invention are preferably supported catalysts. Any suitable refractory catalyst support material, preferably inorganic oxide support materials, can be used as supports for the naphtha hydrotreating catalysts utilized in the present invention. Non-limiting examples of suitable support materials include: zeolites, alumina, silica, and titania. Preferably, the naphtha hydrotreating catalyst support is comprised of an inorganic oxide selected from alumina, silica, and silica-alumina. Most preferred is alumina. In preferred embodiments, the naphtha hydrotreating catalyst has a median pore diameter of about 50 Å to about 500 Å, preferably from about 75 Å to about 250 Å, and more preferably from about 100 Å to about 200 Å.

Preferred operating conditions in the naphtha hydrotreating stage(s) include temperatures from about 450° F. (232° C.) to about 800° F. (427° C.), preferably from about 500° F. (260° C.) to about 675° F. (357° C.); pressures from about 100 to about 800 psig, preferably from about 300 to about 700 psig, more preferably from about 4000 to about 600 psig; hydrogen feed rates of about 1000 to about 6000 standard cubic feet per barrel (scf/b), preferably from about 1000 to about 3000 scf/b; and liquid hourly space velocities of about 0.5 hr⁻¹ to about 15 hr⁻¹, preferably from about 0.5 hr⁻¹ to about 10 hr⁻¹, more preferably from about 1 hr⁻¹ to about 5 hr⁻¹. In preferred embodiments, the naphtha feed to the naphtha hydrotreating stage has a sulfur content of from about 200 wppm to about 5000 wppm, or from about 250 wppm to about 3000 wppm, or from about 500 to about 2500 wppm, while the hydrotreated naphtha product from the naphtha hydrotreating stage has a sulfur content of less than about 100 wppm, or less than about 50 wppm, or less than about 30 wppm, or less than about 15 wppm, or preferably less than about 5 wppm.

In the present embodiments, a naphtha cracking catalyst is utilized in the latter stage(s) of the present invention. In these naphtha cracking stage(s), the hydrotreated naphtha product from the naphtha hydrotreating stage(s) is contacted with a cracking catalyst containing a zeolite under severe operating conditions to a high conversion level of the naphtha as well as to produce a high product content of light plant gases (LPGs) and olefinic chemical feedstocks. LPG is defined herein as any hydrocarbon containing four (4) or less carbon molecules. As noted, one or more naphtha cracking catalysts may be utilized in the present invention.

Preferred naphtha cracking catalysts for use in the naphtha cracking stage(s) is a supported acidic catalyst containing a zeolite with a pore size from about 3 Å to about 8 Å, more preferably from about 5 Å to about 6 Å. In preferred embodiments, the zeolite is a uniform multi-channel zeolite in which the channels differ in average diameter by less than about 15%, or even less than 10%. In preferred embodiments, the zeolite ZSM-5 is utilized. Preferably, the support material is an inorganic oxide selected from alumina, silica, and silica-alumina. Preferably, the support comprised of an inorganic oxide selected from alumina and silica-alumina with a silica-to-alumina ratio of less than 0.1. In a preferred embodiment, the support is comprised of alumina, and in a more preferred embodiment the support is essentially alumina. In preferred embodiments, the naphtha cracking catalysts have a zeolite content of at least 20 wt %, more preferably at least 30 wt %, and even more preferably at least 50 wt % based on the weight of the final supported catalyst. In preferred embodiments, the naphtha cracking catalyst has a median pore diameter of about 50 Å to about 500 Å, preferably from about 75 Å to about 250 Å, and more preferably from about 100 Å to about 200 Å.

While the naphtha cracking catalysts may contain some content of hydrogenation metals (i.e., Group VI or Group VIII metals), it is not required. In preferred embodiments the naphtha cracking catalysts contain less than 5 wt % hydrogenation metals, or even more preferably, the naphtha cracking catalysts utilized in the processes herein contain less than 2 wt % hydrogenation metals, and in most preferred embodiments, the naphtha cracking catalysts contain essentially no hydrogenation metals. If hydrogenation metals are included on the naphtha cracking catalysts, it is preferred that the Group VI metal is Mo and the Group VIII metal is Co.

Preferred operating conditions in the naphtha cracking stage(s) herein include temperatures from about 700° F. (371° C.) to about 900° F. (482° C.), preferably from about 750° F. (399° C.) to about 850° F. (454° C.); pressures from about 400 to about 800 psig, preferably from about 500 to about 750 psig, more preferably from about 550 to about 700 psig; hydrogen feed rates of about 1000 to about 6000 standard cubic feet per barrel (scf/b), preferably from about 1000 to about 3000 scf/b; and liquid hourly space velocities of about 0.5 hr⁻¹ to about 15 hr⁻¹, preferably from about 0.5 hr⁻¹ to about 10 hr⁻¹, more preferably from about 1 hr⁻¹ to about 5 hr⁻¹.

In preferred embodiments of the present invention, the overall naphtha conversion in the process of invention is at least 10 wt %, more preferably at least 20 wt %, and even more preferably at least 25 wt %. The term “naphtha conversion” as used herein is the wt % of the overall naphtha feed (C₅+ compounds) that is converted to lower carbon hydrocarbons (C₄− compounds); “C₅+ compounds” being hydrocarbons with 5 or more carbon atoms, and “C₄− compounds” being hydrocarbons with 4 or less carbon atoms. In preferred embodiments, the total light plant gases produced in the final product of the processes herein is at least 10 wt %, more preferably at least 20 wt %, and even more preferably at least 25 wt % of the total naphtha feed to the process.

Another significant financial benefit associated with this invention is the further significant increase in chemical feedstock products, such as ethylene and propylene. In preferred embodiments of the present invention, the overall naphtha conversion to ethylene and propylene products is at least 1 wt %, more preferably, at least 1.5 wt %, and even more preferably at least 2 wt % (based on the weight of the total naphtha feed to the process).

### ADDITIONAL EMBODIMENTS

Additionally or alternately, the present invention can be described according to any one or more of the following embodiments.

### Embodiment 1

A method for converting a naphtha octane upgrading unit into a naphtha cracking unit comprising:
a) shutting down an existing naphtha octane upgrading unit;
b) removing the existing catalyst from the unit;
c) installing a first naphtha hydrotreating catalyst in at least one first existing reactor of the naphtha octane upgrading unit, wherein the at least one first existing reactor of the naphtha octane upgrading unit becomes part of the first stage of a naphtha cracking process;
d) installing a naphtha cracking catalyst in at least one second existing reactor of the naphtha octane upgrading unit, wherein the at least one second existing reactor stage is in flow series subsequent to the at least one first existing reactor, and the at least one second existing reactor of the naphtha octane upgrading unit becomes part of the second stage of the naphtha cracking process; and
e) modifying existing instrumentation and controls equipment in the first and second stages of the naphtha cracking process to operate under the conditions of the naphtha cracking process.

### Embodiment 2

A method for converting a naphtha octane upgrading unit for use in a naphtha cracking process comprising:
a) shutting down an existing naphtha octane upgrading unit;
b) removing the existing catalyst from the unit;
c) installing a first naphtha hydrotreating catalyst in at least one first existing reactor of the naphtha octane upgrading unit, wherein the at least one first existing reactor of the naphtha octane upgrading unit becomes part of the first stage of the naphtha cracking process;
d) installing a naphtha cracking catalyst in at least one second existing reactor of the naphtha octane upgrading unit, wherein the at least one second existing reactor stage is in flow series subsequent to the at least one first existing reactor, and the at least one second existing reactor of the naphtha octane upgrading unit becomes part of the second stage of the naphtha cracking process;
e) modifying existing instrumentation and controls equipment in the first and second stages of the naphtha cracking process to operate under conditions associated with the naphtha cracking process;
f) conducting a first naphtha feed fraction to the at least one first existing reactor of the naphtha octane upgrading unit;
g) contacting the first naphtha feed fraction with the first naphtha hydrotreating catalyst in the at least one first existing reactor of the naphtha octane upgrading unit under first naphtha hydrotreating conditions to form a first hydrotreated naphtha product;
h) conducting at least a portion of the first hydrotreated naphtha product to the at least one second existing reactor of the naphtha octane upgrading unit;
i) contacting the first hydrotreated naphtha product with the naphtha cracking catalyst in the at least one second existing reactor of the naphtha octane upgrading unit under naphtha cracking conditions to form a first cracked naphtha product; and
j) separating the first cracked naphtha product into at least one light petroleum gas fraction and at least one naphtha fraction.

### Embodiment 3

The method of any prior embodiment, wherein the naphtha octane upgrading unit is a Reforming unit.

### Embodiment 4

The method of any prior embodiment, wherein the existing catalyst is comprised of Pt or Pd.

### Embodiment 5

The method of any prior embodiment, wherein the naphtha octane upgrading is a Platforming unit comprising at least three reactors.

### Embodiment 6

The method of any prior embodiment, wherein the first naphtha hydrotreating catalyst is comprised of at least at least one Group VIII metal oxide and at least one Group VI metal oxide.

### Embodiment 7

The method of any prior embodiment, wherein the first naphtha hydrotreating catalyst is a bulk catalyst.

### Embodiment 8

The method of claim 6, wherein the Group VIII metal oxide is selected from Co and Ni, and the Group VI metal oxide is selected from Mo and W.

### Embodiment 9

The method of any of embodiments 1-6 and 8, wherein the first naphtha hydrotreating catalyst is a supported catalyst wherein the support for the first naphtha hydrotreating catalyst is an inorganic oxide selected from alumina, silica, and silica-alumina.

### Embodiment 10

The method of embodiment 9, wherein the first naphtha hydrotreating catalyst has a median pore diameter of about 50 Å to about 500 Å.

### Embodiment 11

The method of any prior embodiment, wherein a Group VIII metal oxide is present in the first naphtha hydrotreating catalyst in an amount from about 1 to about 12 wt % based on the weight of the final catalyst and a Group VI metal oxide is present in the first naphtha hydrotreating catalyst in an amount from about 2 to about 20 wt % based on the weight of the final catalyst.

### Embodiment 12

The method of any of embodiments 1-6 and 8-11, wherein the naphtha cracking catalyst is a supported acidic catalyst containing a zeolite with a pore size from about 3 Å to about 8 Å.

### Embodiment 13

The method of embodiment 12, wherein the zeolite in the naphtha cracking catalyst is a uniform multi-channel zeolite in which the channels differ in average diameter by less than about 10%.

### Embodiment 14

The method of embodiment 12, wherein the zeolite in the naphtha cracking catalyst is ZSM-5.

### Embodiment 15

The method of embodiment 14, wherein the support of the naphtha cracking catalyst is comprised of alumina, and the zeolite content of the naphtha cracking catalyst is at least 20 wt % based on the weight of the catalyst.

### Embodiment 16

The method of embodiment 15, wherein median pore diameter of the naphtha cracking catalyst is from about 75 Å to about 250 Å.

### Embodiment 17

The method of any of embodiments 2-16, wherein the first naphtha hydrotreating conditions include: temperatures from about 450° F. (232° C.) to about 800° F. (427° C.); pressures from about 300 to about 700 psig; hydrogen feed rates from about 1000 to about 6000 standard cubic feet per barrel (scf/b); and liquid hourly space velocities from about 0.5 hr⁻¹ to about 10 hr⁻¹.

### Embodiment 18

The method of any of embodiments 2-17, wherein the naphtha cracking conditions include: temperatures from about 700° F. (371° C.) to about 900° F. (482° C.); pressures from about 500 to about 750 psig; hydrogen feed rates from about 1000 to about 6000 standard cubic feet per barrel (scf/b); and liquid hourly space velocities from about 0.5 hr⁻¹ to about 10 hr⁻¹.

### Embodiment 19

The method of any of embodiments 2-18, wherein the first naphtha feed fraction has a T5 boiling point of about 80° F. (26.7° C.) and a T95 boiling point of about 450° F. (232.2° C.).

### Embodiment 20

The method of any of embodiments 2-19, wherein the first naphtha feed fraction has a sulfur content of from about 200 wppm to about 5000 wppm, and the first hydrotreated naphtha product has a sulfur content of less than 30 wppm.

### Embodiment 21

The method of any of embodiments 2-20, wherein the amount of naphtha converted in the first cracked naphtha product based on the first naphtha feed fraction is at least 10 wt %.

### Embodiment 22

The method of any of embodiments 2-21, wherein the content of the light petroleum gas fraction is at least 20 wt % of the first cracked naphtha product.

### Embodiment 23

The method of any of embodiments 2-22, wherein ethylene and propylene products are further separated from the light petroleum gas fraction.

### Embodiment 24

The method of embodiment 23, wherein the first naphtha hydrotreating conditions include temperatures from about 750° F. (399° C.) to about 850° F. (454° C.).

### Embodiment 25

The method of embodiment 24, wherein the total ethylene and propylene products are at least 1 wt % of the first naphtha feed fraction.

### Example

In this example, pilot testing was performed on various catalysts and process conditions and the following modeling data was derived therefrom. In this example, Case 1 (comparative) and Case 2 (embodiment of process of invention) shows the products from a two-stage process wherein a naphtha feedstock is first hydrotreated in a first stage and then the hydrotreated naphtha product is cracked in a second stage. In both cases, the naphtha feedstock composition and the catalyst compositions utilized in each stage were the same.

In the naphtha hydrotreating stage, a naphtha feedstock was contacted with a naphtha hydrotreating catalyst. The hydrotreating catalysts in both cases were the same, the catalyst volumes were the same, the inlet pressures were the same (approximately 592 psig), and the hydrogen treat gas ratios were the same (approximately 2365 scf/bbl). The only significant differences were that the liquid hourly space velocity (LHSV) in Case 1 was 1.5 hr⁻¹, where the LHSV in Case 2 it was 2.5 hr⁻¹, and the reactor inlet temperature for Case 1 was 285.0° C. (545.0° F.), wherein Case 2 was 306.0° C. (582.8° F.). The purpose of this step was to remove the sulfur from the naphtha, but not appreciably convert the naphtha to lower molecular weight products.

The products from the naphtha hydrotreating stage were then sent to a naphtha cracking stage. In the cracking stage, the cracking catalysts in both cases were the same (both containing ZSM-5 zeolite), and the catalyst volumes were the same. The only significant differences were that the liquid hourly space velocity (LHSV) in Case 1 was 0.9 hr⁻¹, where the LHSV in Case 2 it was 1.5 hr⁻¹, and the reactor inlet temperature for Case 1 was 372.9° C. (703.2° F.), wherein Case 2 was run under significantly more severe temperature conditions of 399.6° C. (751.3° F.). Case 1 represents a case following the prior art teachings of minimizing naphtha conversion. Case 2 shows an embodiment of the invention wherein the naphtha conversions are maximized, LPG production is significantly increased, and ethylene and propylene productions are maximized. Table 1 shows the final products from comparative Case 1 and embodiment of invention Case 2.

TABLE 1

| | Case 1 | Case 2 |
|---|---|---|
| | (Comparative) | (Invention) |
| Final Products | wt % | wt % |
| H₂S | 0.03 | 0.01 |
| NH₃ | 0.02 | 0.01 |
| C₁ | 0.02 | 0.06 |
| C₂ | 0.30 | 0.73 |
| C₃═ | 0.15 | 0.65 |
| C₃ | 2.54 | 11.19 |
| C₄═ | 0.28 | 1.22 |
| iC₄ | 1.29 | 5.71 |
| nC₄ | 1.50 | 6.63 |
| C₅+ | 93.88 | 73.79 |

In particular, Table 2 shows the important comparisons of overall naphtha conversion in the product (Naphtha Conversion), total light plant gases (LPG Production) produced, and total ethylene and propylene produced (C₃=+C₄=Production).

TABLE 2

| | Case 1 | Case 2 |
|---|---|---|
| | (Comparative) | (Invention) |
| Final Products | wt % | wt % |
| Naphtha Conversion | 6.12 | 26.21 |
| LPG Production | 6.08 | 26.19 |
| C₃═ + C₄═ | 0.42 | 1.87 |
| Production | | |

As can be seen, the process of invention, as embodied in Case 2, produces significantly more valuable LPG and especially additional valuable chemical feedstocks (ethylene and propylene). The invention also has the added benefit of reducing the overproduction of naphtha products in a refinery. These processes can be performed by converting an existing naphtha upgrading unit into the processes of invention.

What is claimed is:

1. A method for converting a naphtha octane upgrading unit into a naphtha cracking unit comprising:
a) shutting down an existing naphtha octane upgrading unit;
b) removing the existing catalyst from the unit;
c) installing a first naphtha hydrotreating catalyst in at least one first existing reactor of the naphtha octane upgrading unit, wherein the at least one first existing reactor of the naphtha octane upgrading unit becomes part of the first stage of a naphtha cracking process;
d) installing a naphtha cracking catalyst in at least one second existing reactor of the naphtha octane upgrading unit, wherein the at least one second existing reactor stage is in flow series subsequent to the at least one first existing reactor, and the at least one second existing reactor of the naphtha octane upgrading unit becomes part of the second stage of the naphtha cracking process; and
e) modifying existing instrumentation and controls equipment in the first and second stages of the naphtha cracking process to operate under the conditions of the naphtha cracking process.

2. The method of claim 1, wherein the naphtha octane upgrading unit is a Reforming unit.

3. The method of claim 2, wherein the existing catalyst is comprised of Pt or Pd.

4. The method of claim 2, wherein the naphtha octane upgrading is a Platforming unit comprising at least three reactors.

5. The method of claim 1, wherein the first naphtha hydrotreating catalyst is comprised of at least at least one Group VIII metal oxide and at least one Group VI metal oxide.

6. The method of claim 5, wherein the first naphtha hydrotreating catalyst is a bulk catalyst.

7. The method of claim 5, wherein the Group VIII metal oxide is selected from Co and Ni, and the Group VI metal oxide is selected from Mo and W.

8. The method of claim 7, wherein the first naphtha hydrotreating catalyst is a supported catalyst wherein the support for the first naphtha hydrotreating catalyst is an inorganic oxide selected from alumina, silica, and silica-alumina.

9. The method of claim 8, wherein the first naphtha hydrotreating catalyst has a median pore diameter of about 50 Å to about 500 Å.

10. The method of claim 9, wherein the Group VIII metal oxide is present in the first naphtha hydrotreating catalyst in an amount from about 1 to about 12 wt % based on the weight of the final catalyst and the Group VI metal oxide is present in the first naphtha hydrotreating catalyst in an amount from about 2 to about 20 wt % based on the weight of the final catalyst.

11. The method of claim 8, wherein the naphtha cracking catalyst is a supported acidic catalyst containing a zeolite with a pore size from about 3 Å to about 8 Å.

12. The method of claim 11, wherein the zeolite in the naphtha cracking catalyst is a uniform multi-channel zeolite in which the channels differ in average diameter by less than about 10%.

13. The method of claim 11, wherein the zeolite in the naphtha cracking catalyst is ZSM-5.

14. The method of claim 13, wherein the support of the naphtha cracking catalyst is comprised of alumina, and the zeolite content of the naphtha cracking catalyst is at least 20 wt % based on the weight of the catalyst.

15. The method of claim 14, wherein median pore diameter of the naphtha cracking catalyst is from about 75 Å to about 250 Å.

16. A method for converting a naphtha octane upgrading unit for use in a naphtha cracking process comprising:
a) shutting down an existing naphtha octane upgrading unit;
b) removing the existing catalyst from the unit;
c) installing a first naphtha hydrotreating catalyst in at least one first existing reactor of the naphtha octane upgrading unit, wherein the at least one first existing reactor of the naphtha octane upgrading unit becomes part of the first stage of the naphtha cracking process;
d) installing a naphtha cracking catalyst in at least one second existing reactor of the naphtha octane upgrading unit, wherein the at least one second existing reactor stage is in flow series subsequent to the at least one first existing reactor, and the at least one second existing reactor of the naphtha octane upgrading unit becomes part of the second stage of the naphtha cracking process;
e) modifying existing instrumentation and controls equipment in the first and second stages of the naphtha cracking process to operate under conditions associated with the naphtha cracking process;
f) conducting a first naphtha feed fraction to the at least one first existing reactor of the naphtha octane upgrading unit;
g) contacting the first naphtha feed fraction with the first naphtha hydrotreating catalyst in the at least one first existing reactor of the naphtha octane upgrading unit under first naphtha hydrotreating conditions to form a first hydrotreated naphtha product;
h) conducting at least a portion of the first hydrotreated naphtha product to the at least one second existing reactor of the naphtha octane upgrading unit;
i) contacting the first hydrotreated naphtha product with the naphtha cracking catalyst in the at least one second existing reactor of the naphtha octane upgrading unit under naphtha cracking conditions to form a first cracked naphtha product; and
j) separating the first cracked naphtha product into at least one light petroleum gas fraction and at least one naphtha fraction.

17. The method of claim 16, wherein the naphtha octane upgrading unit is a Reforming unit.

18. The method of claim 17, wherein the existing catalyst is comprised of Pt or Pd.

19. The method of claim 17, wherein the naphtha octane upgrading is a Platforming unit comprising at least three reactors.

20. The method of claim 16, wherein the first naphtha hydrotreating catalyst is comprised of at least at least one Group VIII metal oxide and at least one Group VI metal oxide.

21. The method of claim 20, wherein the first naphtha hydrotreating catalyst is a bulk catalyst.

22. The method of claim 20, wherein the Group VIII metal oxide is selected from Co and Ni, and the Group VI metal oxide is selected from Mo and W.

23. The method of claim 22, wherein the first naphtha hydrotreating catalyst is a supported catalyst wherein the support for the first naphtha hydrotreating catalyst is an inorganic oxide selected from alumina, silica, and silica-alumina.

24. The method of claim 23, wherein the first naphtha hydrotreating catalyst has a median pore diameter of about 50 Å to about 500 Å.

25. The method of claim 24, wherein the Group VIII metal oxide is present in the first naphtha hydrotreating catalyst in an amount from about 1 to about 12 wt % based on the weight of the final catalyst and the Group VI metal oxide is present in the first naphtha hydrotreating catalyst in an amount from about 2 to about 20 wt % based on the weight of the final catalyst.

26. The method of claim 23, wherein the naphtha cracking catalyst is a supported acidic catalyst containing a zeolite with a pore size from about 3 Å to about 8 Å.

27. The method of claim 26, wherein the zeolite in the naphtha cracking catalyst is a uniform multi-channel zeolite in which the channels differ in average diameter by less than about 10%

28. The method of claim 26, wherein the zeolite in the naphtha cracking catalyst is ZSM-5.

29. The method of claim 28, wherein the support of the naphtha cracking catalyst is comprised of alumina, and the zeolite content of the naphtha cracking catalyst is at least 20 wt % based on the weight of the catalyst.

30. The method of claim 29, wherein median pore diameter of the naphtha cracking catalyst is from about 75 Å to about 250 Å.

31. The method of claim 28, wherein the first naphtha hydrotreating conditions include: temperatures from about 450° F. (232° C.) to about 800° F. (427° C.); pressures from about 300 to about 700 psig; hydrogen feed rates from about 1000 to about 6000 standard cubic feet per barrel (scf/b); and liquid hourly space velocities from about 0.5 hr⁻¹ to about 10 hr⁻¹.

32. The method of claim 31, wherein the naphtha cracking conditions include: temperatures from about 700° F. (371° C.) to about 900° F. (482° C.); pressures from about 500 to about 750 psig; hydrogen feed rates from about 1000 to about 6000 standard cubic feet per barrel (scf/b); and liquid hourly space velocities from about 0.5 hf⁻¹ to about 10 hr⁻¹.

33. The method of claim 32, wherein the first naphtha hydrotreating conditions include temperatures from about 750° F. (399° C.) to about 850° F. (454° C.).

34. The method of claim 32, wherein the first naphtha feed fraction has a T5 boiling point of about 80° F. (26.7° C.) and a T95 boiling point of about 450° F. (232.2° C.).

35. The method of claim 34, wherein the first naphtha feed fraction has a sulfur content of from about 200 wppm to about 5000 wppm, and the first hydrotreated naphtha product has a sulfur content of less than 30 wppm.

36. The method of claim 35, wherein the amount of naphtha converted in the first cracked naphtha product based on the first naphtha feed fraction is at least 10 wt %.

37. The method of claim 36, wherein the content of the light petroleum gas fraction is at least 20 wt % of the first cracked naphtha product.

38. The method of claim 37, wherein ethylene and propylene products are further separated from the light petroleum gas fraction.

39. The method of claim 38, wherein the first naphtha hydrotreating conditions include temperatures from about 750° F. (399° C.) to about 850° F. (454° C.).

40. The method of claim 39, wherein the total ethylene and propylene products are at least 1 wt % of the first naphtha feed fraction.
